(19) United States
(12) Patent Application Publication
(10) Pub. No.: US 2021/0192125 A1
(43) Pub. Date: Jun. 24, 2021

(54) METHODS AND SYSTEMS FOR FACILITATING SUMMARIZATION OF A DOCUMENT

(71) Applicant: Catachi Co. DBA Compliance.ai, San Francisco, CA (US)

(72) Inventors: Danielle Lee Deibler, San Francisco, CA (US); Brendan Callahan, San Francisco, CA (US); Christopher Walker, San Francisco, CA (US)

(21) Appl. No.: 17/127,181

(22) Filed: Dec. 18, 2020

Related U.S. Application Data
(60) Provisional application No. 62/949,738, filed on Dec. 18, 2019.

(51) Int. Cl. G06F 40/166; G06F 16/93; G06F 16/33; G06F 16/34; G06F 16/23; G06F 40/289

(52) U.S. Cl. CPC G06F 40/166; G06F 16/93; G06F 40/289; G06F 16/345; G06F 16/2365; G06F 16/3344

(57) ABSTRACT

Disclosed herein is a method for facilitating summarization of a document. Accordingly, the method may include receiving, using a communication device, the document from a user device, analyzing, using a processing device, the document, and generating, using the processing device, an initial summary of the document based on the analyzing of the document. Further, the method may include retrieving, using a storage device, a ground truth metric document associated with the document. Further, the method may include analyzing, using the processing device, the initial summary based on the ground truth metric document. Further, the method may include modifying, using the processing device, the initial summary based on the analyzing of the initial summary. Further, the method may include generating, using the processing device, a final summary of the document based on the modifying. Further, the method may include transmitting, using the communication device, the final summary to the user device.

The current application claims a priority to the U.S. Provisional Patent application Ser. No. 62/949,738 filed on Dec. 18, 2019.

### FIELD OF THE INVENTION

Generally, the present disclosure relates to the field of data processing. More specifically, the present disclosure relates to methods and systems for facilitating summarization of a document.

### BACKGROUND OF THE INVENTION

Generally, documentation may be described as keeping a written and retaining a record of events. Documentation may include elements that may be required to be included, such as policies, practice, and rules. Further, documentation may be described as a written record of actions, discussion, incidents, disciplinary action, positive contributions, reward and recognition, investigations, failure to accomplish requirements and goals, and performance evaluations kept by authorities.

Accordingly, the summarization of documents is of utmost importance. Summarization may help individuals, and organizations to retrieve all the information in a document in a set timeframe. The information may be particular to a specific time and may pertain to one, or multiple topics or individuals. As such, if the documents are summarized with respect to categories, topics, headings, periods, and so on, the display of all the important information in the document becomes easier to accomplish. Existing systems to summarize the documents employ machine-learning techniques. Further, many current technologies make use of human input to summarize the documents. However, current technologies to summarize the documents do not assign a weightage to individual sentences of the document and ranking sentences of the document, and generating the summary of the document by combining the highest weighted sentences of the document in the correct order. Further, current technologies to summarize the documents do not include generate the summary of the document by combining the highest weighted sentences of individual topics and headings in the document in correct order to include all the headings of the document. Further, current technologies to summarize the documents do not use input from multiple human experts to assign weights to sentences in the document and capture the sentence ranking preferences from human experts. Further, current technologies to summarize the documents do not make use of a hierarchical system of multiple experts to summarize the documents, and supervise improve the machine learning procedure and algorithms to summarize the documents. Further, current technologies to summarize the documents do not compare generated summaries with ground truth metric documents to verify the correctness and completeness of the summaries. Further, current technologies to summarize the documents do not create the summaries in the form of tables and charts depicting the content present in the original documents.

Therefore, there is a need for improved methods and systems for facilitating summarization of a document that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating summarization of a document, in accordance with some embodiments. Accordingly, the method may include receiving, using a communication device, the document from at least one user device. Further, the method may include a step of analyzing, using a processing device, the document. Further, the method may include a step of generating, using the processing device, an initial summary of the document based on the analyzing of the document. Further, the method may include a step of retrieving, using a storage device, a ground truth metric document associated with the document. Further, the ground truth metric document may include a reference summary. Further, the reference summary may include one or more reference points describing one or more reference concepts and one or more reference relationships between the one or more reference concepts. Further, the method may include a step of analyzing, using the processing device, the initial summary based on the ground truth metric document. Further, the method may include a step of modifying, using the processing device, the initial summary based on the analyzing of the initial summary. Further, the method may include a step of generating, using the processing device, a final summary of the document based on the modifying. Further, the method may include a step of transmitting, using the communication device, the final summary to the at least one user device.

Further disclosed herein is a system for facilitating summarization of a document, in accordance with some embodiments. Accordingly, the system may include a communication device configured for receiving the document from at least one user device. Further, the communication device may be configured for transmitting a final summary to the at least one user device. Further, the system may include a processing device communicatively coupled with the communication device. Further, the processing device may be configured for analyzing the document. Further, the processing device may be configured for generating an initial summary of the document based on the analyzing of the document. Further, the processing device may be configured for analyzing the initial summary based on a ground truth metric document. Further, the processing device may be configured for modifying the initial summary based on the analyzing of the initial summary. Further, the processing device may be configured for generating the final summary of the document based on the modifying. Further, the system may include a storage device communicatively coupled with the processing device. Further, the storage device may be configured for retrieving the ground truth metric document associated with the document. Further, the ground truth metric document may include a reference summary. Further, the reference summary may include one or more reference points describing one or more reference concepts and one or more reference relationships between the one or more reference concepts.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating summarization of a document, in accordance with some embodiments.

FIG. 3 is a flowchart of a method for facilitating summarization of a document, in accordance with some embodiments.

FIG. 4 is a flowchart of a method for identifying one or more meaningful units for facilitating the summarization of the document, in accordance with some embodiments.

FIG. 5 is a flowchart of a method for comparing a modified rank of the each meaningful unit of the plurality of meaningful units with the predetermined rank for facilitating the summarization of the document, in accordance with some embodiments.

FIG. 6 is a flowchart of a method for identifying one or more meaningful units of the plurality of meaningful units for facilitating the summarization of the document, in accordance with some embodiments.

FIG. 7 is a flowchart of a method for comparing a lower level consistency with a predetermined range of the lower level consistency for the each meaningful unit of the plurality of meaningful units for facilitating the summarization of the document, in accordance with some embodiments.

FIG. 8 is a flowchart of a method for comparing a higher level consistency with a predetermined range of the higher level consistency for the each meaningful unit of the plurality of meaningful units for facilitating the summarization of the document, in accordance with some embodiments.

FIG. 9 is a flowchart of a method for determining at least one relationship between at least one concept and at least one reference for facilitating the summarization of the document, in accordance with some embodiments.

FIG. 10 is a flowchart of a method for determining at least one relationship between the at least one concept and the at least one reference for facilitating the summarization of the document, in accordance with some embodiments.

FIG. 11 is a flowchart of a method to facilitate the summarization of regulatory documents, in accordance with some embodiments.

FIG. 12 is a flowchart of a method to facilitate the summarization of a regulatory document, in accordance with some embodiments.

FIG. 13 is a flowchart of a method to facilitate the summarization of a regulatory document, in accordance with some embodiments.

FIG. 14 illustrates a system to facilitate the summarization of a regulatory document in accordance with some embodiments.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating summarization of a document, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods and systems for facilitating summarization of a document. Further, the document may include a regulatory document. Further, the disclosed system may be configured for facilitating the automatic summarization of the regulatory documents. Further, the regulatory documents may include, but may not be limited to legal documents including regulations, and laws, medical documents including research papers, and case studies, and documents related to any other field of study or research. The regulatory documents may be retrieved and accessed from external connected databases (or databases). The databases may include legal databases, medical databases, engineering, and architectural databases, and so on.

Further, the disclosed system may include a user device that a user may use to access the disclosed system. The user device may be a mobile device such as, but not limited to, a smartphone, or a computer tablet, or a computing device like a personal computer, or a laptop. The user device may include a communication device configured to communicate over a communication network such as, but not limited to, a cellular network, a satellite network, a personal area network, Bluetooth, Internet, and so on. Further, the user device may include sensors.

Further, the disclosed system may allow users to register and create user profiles. Accordingly, the user profiles may include information about the name, age, gender, location, and so on about the users. Further, the user profiles may include information about the profession of the users, such as a lawyer, doctor, and so on.

Further, the summarization procedure of the regulatory document may involve the analysis of individual sentences of the regulatory document. Each sentence in the regulatory document may be analyzed, and the value of the sentence may be determined. Accordingly, the sentences with more value may be used in the process of summarization. Further, the process of summarization of the regulatory documents may be improved with the help of human expert judgment. Human expert judgment may be obtained from the users, that may be expert and proficient in specific fields and areas of study. Human experts may judge the importance of sentences in a regulatory document by reading, and analyzing the regulatory documents based on topics, special keywords, context, and so on. Further, the human experts may give scores to sentences, and the most weighted sentences may be prioritized for the process of generation of the summary.

Further, the sentences in the regulatory documents may be assigned weights based on topics in the regulatory document, genre, and heading of the regulatory document, and other corpus heterogeneity.

Further, multiple regulatory documents that may be interlinked through references and citations may be summarized. The linked regulatory documents may be analyzed based on important links, references, and citations between the regulatory documents. Further, the links, references, and citations may be analyzed and reduced to simple sentences and facts. The simple sentences and facts may represent the information in the multiple interlinked regulatory documents. Accordingly, simple sentences and facts may be expressed and written in the form of natural English language sentences.

Further, the disclosed system may be configured for generating a text summary of a document (e.g. regulator document) based on scoring the value of each sentence for its use in a text summary of the document, as validated by the feedback of expert judges and other ground truth metrics. Further, the disclosed system may be configured for assigning weights to sentences for summarization based on topic, genre, rates of compression, or other corpus heterogeneity. Further, the disclosed system may be configured for generating summaries of multiple documents (e.g. regulatory documents) based on important links and similarities between the concepts, references, and documents, and compressing these concepts down to the most important facts and expressing those facts in the form of natural English sentences. Further, the disclosed system may be configured for generating summaries of multiple documents in the form of tables and charts based on citation analysis.

Further, using a combination of summarization techniques, the disclosed system may be configured for summarizing documents related to regulation. Further, extractive summarization associated with the disclosed system may include the collection and application of sentence-ranking data regarding regulatory compliance documents.

Further, using a narrowly-tailored word- and sentence-segmentation process associated with the disclosed system, the disclosed system may provide text summaries that are “compressions” of the original text—achieved via sentence extraction. Further, the novel text summaries may be assembled from contents of the document(s) being summarized by scoring the value of each sentence for its use in a text summary of the document, as validated by the feedback of expert judges and other ground-truth metrics. A weighted-feature approach to sentence scoring lays the foundation for a number of learned and hand-tuned strategies that can be effectively tuned to accommodate different topics, genres, rates of compression, or other corpus heterogeneity. Further, the disclosed system may follow best practices and instrumentation for the capture of sentence ranking preferences from domain experts. Further, the disclosed system may follow best practices and instrumentation for the evaluation of summary proposals. Further, the disclosed system may be configured for genre-specific sentence segmentation and classification. Further, the disclosed system may be configured for genre-specific word tokenization sensitive to domain names and citation patterns. Further, the disclosed system may be associated with genre-specific weighted-feature scoring algorithms for sentence ranking (and iterative re-ranking) to aid in sentence selection for summary construction. Further, abstractive summarization associated with the disclosed system may include a novel slot-driven document and multi-document summarizer producing textual summaries. Using scrapers, crawlers, and Natural Language Processing techniques, the disclosed system provides text summaries that represent the distillation of the content of regulatory documents into a newly-created passage of text reflecting the most important themes or topics in those documents. Further, the disclosed system may identify key concepts and references in the documents; then we establish the important links and similarities between the concepts, references, and documents. Further, the disclosed system may compress these concepts down to the most important facts and express those facts in the form of natural English sentences. Further, the disclosed system may be configured for identification, classification, and resolution of document citations in the text using a novel blend of learned, manual, and rule-based approaches. Further, the disclosed system may be configured for the extraction, classification, and resolution (or disambiguation) of a number of genre-specific attributes including names of people and organizations, amounts of money, legal actions and outcomes, dates, requirements, etc. Further, the disclosed system may be associated with algorithms and models for the construction of text passages using the information provided in genre-specific slots filled by the items extracted from the text(s) being summarized.

Further, the disclosed system may be configured for numeric summarization. Further, the disclosed system may be associated with a slot-driven document and multi-document summarizer producing tabular and chart summaries. Using scrapers, crawlers, and Natural Language Processing techniques, the disclosed system may provide numerical summaries that represent the distillation of the content of regulatory documents into a newly-created passage of text reflecting the most important themes or topics in those documents. Further, the disclosed system may be configured for identifying key concepts and references in the documents and then establishing the important links and similarities between the concepts, references, and documents, and then compressing these concepts down to the most important facts and express those facts in the form of tables and charts of statistical summaries. Further, the disclosed system may be configured for the identification, classification, and resolution of document citations in the text using a novel blend of learned, manual, and rule-based approaches. Further, the disclosed system may be configured for the extraction, classification, and resolution (or disambiguation) of a number of genre-specific attributes including names of people and organizations, amounts of money, legal actions and outcomes, dates, requirements, etc. Further, the disclosed system may be associated with algorithms and models for the construction of tables and charts using the information provided in genre-specific slots filled by the items extracted from the text(s) being summarized.

Further, the disclosed system may be configured for generating navigable citation-based graph UI for regulatory documents. Using scrapers, crawlers, and Natural Language Processing techniques, the disclosed system may be configured for identifying links between regulatory documents and provide a novel visualization for inspecting the impact and similarity of all the documents linked to a given one. Further, the disclosed system may be configured for the identification, classification, and resolution of document citations in the text using a novel blend of learned, manual, and programmed approaches.

Further, filtering recent documents by topic is an important aspect of regulatory change management. Further, the disclosed system may be configured for the surfacing and automatic classification of regulatory documents. Further, the disclosed system may be configured for generating topic classification (or filters) of documents (e.g. regulatory documents) based on a blend of expert task specification, assessment, human-driven real-time classification, statistical judgment prioritization, and machine learning techniques. Further, the disclosed system may apply filter attributes to both recent additions and historically-published documents found in the disclosed system. These filters are then made available to regulatory compliance workers using a proprietary web UI which also allows them to provide their expert feedback. Further, the disclosed system may be configured for the creation and validation of repeatable, consistent guidelines for human judgment tasks about classification problems, especially “topic” classification, but also other kinds of relevance. Further, the disclosed system may be configured for the rapid creation of training data in support of machine learning for document classification. Further, the disclosed system may include a specialized judgment interface configurable for a wide variety of human judgment tasks relevant to the semantics of regulatory documents in the financial domain. Further, the disclosed system may include a specialized queueing and sampling infrastructure designed to optimize both the performance of the learned models and the efficiency of the human judges. Further, the disclosed system may emphasize client-facing accuracy over learned-model accuracy. Further, the disclosed system may be associated with a flexible framework capable of supporting arbitrary document classification tasks.

Further, the disclosed system may be configured for generating navigable citation-based graph UI for regulatory documents. Using scrapers, crawlers, and Natural Language Processing techniques, the disclosed system may be configured for identifying links between regulatory documents and provide a novel visualization for inspecting the impact and similarity of all the documents linked to a given one. Further, the disclosed system may be configured for the identification, classification, and resolution of document citations in the text using a novel blend of learned, manual, and programmed approaches. Further, the disclosed system may be configured for the retrieval and display of citation-connected regulatory documents collected from various state and federal agencies. Further, the disclosed system may be configured for generating circles and line graph visualization of document co-citation that encodes document attributes such as genre, jurisdiction, and impact using visual cues such as shape, size, and color.

Further, the disclosed system may use a connected-graph based technique for automatic topic classification and discovery. Using scrapers, crawlers, and Natural Language Processing techniques, the disclosed system may be configured for identifying clusters of closely related documents and provide a novel interface for their inspection, navigation, and aggregation. Further, the disclosed system may be configured for identification, classification, and resolution of document citations in the text using a novel blend of learned, manual, and rule-based approaches. Further, the disclosed system may be configured for unique citation-based document representation. Further, the disclosed system may use unsupervised clustering techniques based on our unique graph-based document representation. Further, the disclosed system may be associated with a user interface for the ranked presentation of the most similar documents for each document (that has either incoming or outgoing citations).

Further, the disclosed system may use a combination of summarization techniques we have developed a proprietary model for summarizing documents related to regulation. Further, the disclosed system may be configured for generating a text summary of a document (e.g. regulatory document) based on scoring the value of each sentence for its use in a text summary of the document, as validated by the feedback of expert judges and other ground-truth metrics. Further, the disclosed system may be configured for assigning weights to sentences for summarization based on topics, genres, rates of compression, or other corpus heterogeneity. Further, the disclosed system may be configured for generating summaries of multiple documents (e.g. regulatory documents) based on important links and similarities between the concepts, references, and documents and compressing these concepts down to the most important facts; and expressing those facts in the form of natural English sentences. Further, the disclosed system may be configured for generating summaries of multiple documents in the form of tables and charts based on citation analysis.

Variable-length summaries are constructed via an iterative 1-best sentence extraction process leveraging, among other features: depth in the document, depth in the section, topic-relevance, topic-diversity, discourse coherence, “slot” coverage (e.g. “respondent”, “violation”, “penalty” and “enforcement action type” for regulatory enforcement documents), summary “cue score” (i.e. the similarity of the sentence to summaries previously seen), and other proprietary document and sentence understanding-related features. The key distinguishing features of the disclosed system are: (1) the ability to vary the “compression rate” of the summarization engine to accommodate various summarization needs and (2) a suite of re-weighting strategies sensitive to this variability and optimized toward summaries that gracefully balance topic relevance, subtopic diversity and contextual coherence. Both word scoring and sentence selection weights are “learned” from text data using a variety of supervised and unsupervised methods familiar within ML.

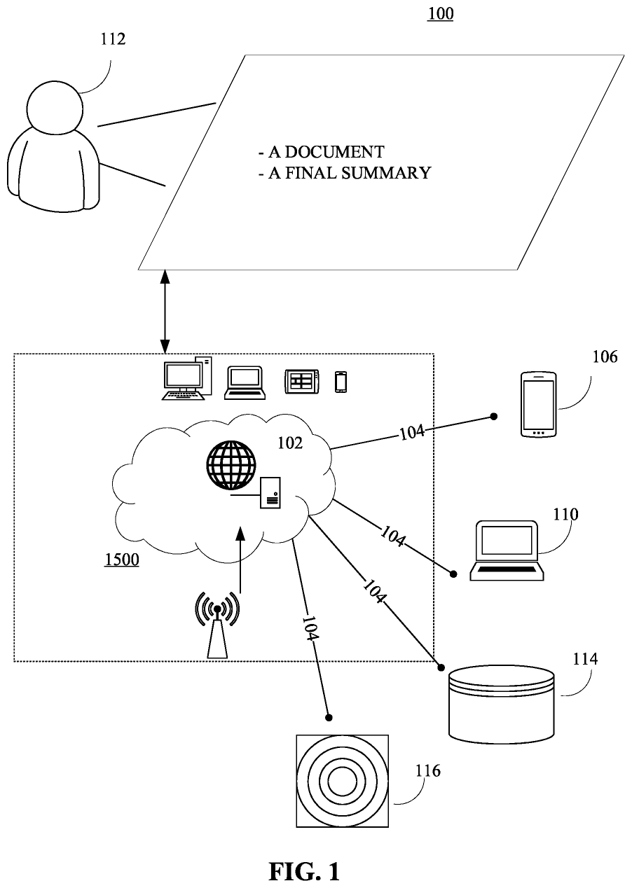

Referring now to figures, FIG. 1 is an illustration of an online platform 100 consistent with various embodiments of the present disclosure. By way of non-limiting example, the online platform 100 to facilitate summarization of a document may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1500.

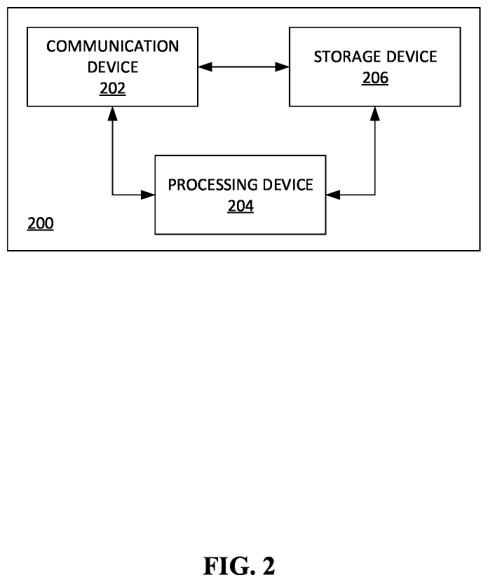

FIG. 2 is a block diagram of a system 200 for facilitating summarization of a document, in accordance with some embodiments. Accordingly, the system 200 may include a communication device 202 configured for receiving the document from at least one user device. Further, the communication device 202 may be configured for transmitting a final summary to the at least one user device. Further, the document may include a regulatory document.

Further, the system 200 may include a processing device 204 communicatively coupled with the communication device 202. Further, the processing device 204 may be configured for analyzing the document. Further, the processing device 204 may be configured for generating an initial summary of the document based on the analyzing of the document. Further, the processing device 204 may be configured for analyzing the initial summary based on a ground truth metric document. Further, the processing device 204 may be configured for modifying the initial summary based on the analyzing of the initial summary. Further, the processing device 204 may be configured for generating the final summary of the document based on the modifying.

Further, the system 200 may include a storage device 206 communicatively coupled with the processing device 204. Further, the storage device 206 may be configured for retrieving the ground truth metric document associated with the document. Further, the ground truth metric document may include a reference summary. Further, the reference summary may include one or more reference points describing one or more reference concepts and one or more reference relationships between the one or more reference concepts.

Further, in some embodiments, the processing device 204 may be configured for segmenting the document into a plurality of meaningful units based on the analyzing of the document. Further, the processing device 204 may be configured for analyzing the plurality of meaningful units based on the segmenting. Further, the processing device 204 may be configured for determining an importance of each meaningful unit of the plurality of meaningful units to render meaning to the document based on the analyzing of the plurality of meaningful units. Further, the processing device 204 may be configured for assigning a rank of a plurality of ranks to the each meaningful unit of the plurality of meaningful units based on the determining of the importance. Further, the processing device 204 may be configured for comparing the rank of the each meaningful unit with a predetermined rank. Further, the processing device 204 may be configured for identifying one or more meaningful units of the plurality of meaningful units based on the comparing. Further, the generating of the initial summary may be based on the identifying of the one or more meaningful units.

Further, in some embodiments, the communication device 202 may be configured for transmitting the plurality of meaningful units, the plurality of ranks associated with the plurality of meaningful units, and the document to one or more user devices associated with one or more users. Further, the communication device 202 may be configured for receiving first input data associated with at least one rank of the plurality of ranks from the one or more user devices. Further, the processing device 204 may be configured for analyzing the first input data. Further, the processing device 204 may be configured for determining a plurality of modified ranks for the plurality of meaningful units based on the analyzing of the first input data. Further, the processing device 204 may be configured for assigning the plurality of modified ranks to the plurality of meaningful units based on the determining of the plurality of modified ranks. Further, the processing device 204 may be configured for comparing a modified rank of the each meaningful unit of the plurality of meaningful units with the predetermined rank based on the assigning of the plurality of modified ranks. Further, the identifying of the one or more meaningful units may be based on the comparing of the modified rank.

Further, in some embodiments, the processing device 204 may be configured for segmenting the document into a plurality of meaningful units based on the analyzing of the document. Further, the processing device 204 may be configured for assigning a plurality of ranks to the plurality of meaningful units based on the receiving of input data. Further, the processing device 204 may be configured for comparing a rank of each meaningful unit of the plurality of meaningful units with a predetermined rank. Further, the processing device 204 may be configured for identifying one or more meaningful units of the plurality of meaningful units based on the comparing. Further, the communication device 202 may be configured for transmitting the plurality of meaningful units and the document to one or more user devices associated with one or more users. Further, the communication device 202 may be configured for receiving the input data from the one or more user devices. Further, the input data may include the plurality of ranks for the plurality of meaningful units. Further, the generating of the initial summary may be based on the identifying of the one or more meaningful units.

Further, in some embodiments, the storage device 206 may be configured for retrieving a plurality of user identifiers associated with a plurality of users. Further, the plurality of users may be associated with a plurality of hierarchical levels of a proficiency in at least one domain. Further, the at least one domain may include a field of study, an area of service, etc. Further, the document may be associated with the at least one domain. Further, the processing device 204 may be configured for identifying a plurality of lower level user identifiers of the plurality of user identifiers associated with a plurality of lower level users of the plurality of users. Further, the plurality of lower level users may be associated with a lower hierarchical level of the plurality of hierarchical levels. Further, the one or more user devices may include a plurality of lower level user devices. Further, the transmitting of the plurality of meaningful units and the document to the plurality of lower level user devices may be based on the identifying of the plurality of lower level user identifiers. Further, the input data may include a plurality of lower level input data. Further, the receiving of the plurality of lower level input data from the plurality of lower level user devices may be based on the transmitting of the plurality of meaningful units and the document to the plurality of lower level user devices. Further, the processing device 204 may be configured for analyzing the plurality of lower level input data. Further, the plurality of lower level input data may include a plurality of lower level ranks for the each meaningful unit of the plurality of meaningful units. Further, the processing device 204 may be configured for determining a lower level consistency of the plurality of lower level ranks for the each meaningful unit based on the analyzing of the plurality of lower level input data. Further, the processing device 204 may be configured for comparing the lower level consistency with a predetermined range of the lower level consistency for the each meaningful unit of the plurality of meaningful units. Further, the assigning of the plurality of ranks to the plurality of meaningful units may be based on the comparing of the lower level consistency for the each meaningful unit of the plurality of meaningful units.

Further, in some embodiments, the processing device 204 may be configured for identifying a plurality of higher level user identifiers of the plurality of user identifiers associated with a plurality of higher level users of the plurality of users based on the determining of the lower level consistency. Further, a number of the plurality of higher level users may be lower than a number of the plurality of lower level users. Further, the plurality of higher level users may be associated with a higher hierarchical level of the plurality of hierarchical levels. Further, the one or more user devices may include a plurality of higher level user devices. Further, the transmitting of the plurality of meaningful units and the document to the plurality of higher level user devices may be based on the identifying of the plurality of higher level user identifiers. Further, the input data may include a plurality of higher level input data. Further, the receiving of the plurality of higher level input data from the plurality of higher level user devices may be based on the transmitting of the plurality of meaningful units and the document to the plurality of higher level user devices. Further, the processing device 204 may be configured for analyzing the plurality of higher level input data. Further, the plurality of higher level input data may include a plurality of higher level ranks for the each meaningful unit of the plurality of meaningful units. Further, the processing device 204 may be configured for determining a higher level consistency of the plurality of higher level ranks for the each meaningful unit based on the analyzing of the plurality of higher level input data and the analyzing of the plurality of lower level input data. Further, the processing device 204 may be configured for comparing the higher level consistency with a predetermined range of the higher level consistency for the each meaningful unit of the plurality of meaningful units. Further, the assigning of the plurality of ranks to the plurality of meaningful units may be based on the comparing of the higher level consistency for the each meaningful unit of the plurality of meaningful units.

Further, in some embodiments, the processing device 204 may be configured for identifying at least one concept and at least one reference associated with the document based on the analyzing of the document. Further, the processing device 204 may be configured for analyzing the at least one concept and the at least one reference. Further, the processing device 204 may be configured for determining at least one relationship between the at least one concept and the at least one reference based on the analyzing of the at least one concept and the at least one reference. Further, the generating of the initial summary may be based on the determining of the at least one relationship. Further, the generating of the initial summary may include creating at least one natural language sentence based on the at least one relationship between the at least one concept and the at least one reference. Further, the at least one natural language sentence may include an English language sentence.

Further, in some embodiments, the processing device 204 may be configured for identifying at least one concept and at least one reference associated with the document based on the analyzing of the document. Further, the processing device 204 may be configured for analyzing the at least one concept and the at least one reference. Further, the processing device 204 may be configured for determining at least one relationship between the at least one concept and the at least one reference based on the analyzing of the at least one concept and the at least one reference. Further, the generating of the initial summary may be based on the determining. Further, the generating of the initial summary may include creating at least one fact based on the at least one relationship between the at least one concept and the at least one reference. Further, the at least one fact may be expressed in at least one statistical representation. Further, the at least one statistical representation may include a table, a chart, etc.

Further, in some embodiments, the modifying of the initial summary may include adding at least one reference point of the one or more reference points of the reference summary to the initial summary. Further, the generating of the final summary of the document may be based on the adding.

Further, in some embodiments, the analyzing of the initial summary may include comparing the initial summary and the reference summary. Further, the processing device 204 may be configured for determining a correctness of the initial summary based on the comparing of the initial summary and the reference summary. Further, the modifying of the initial summary may be based on the determining of the correctness.

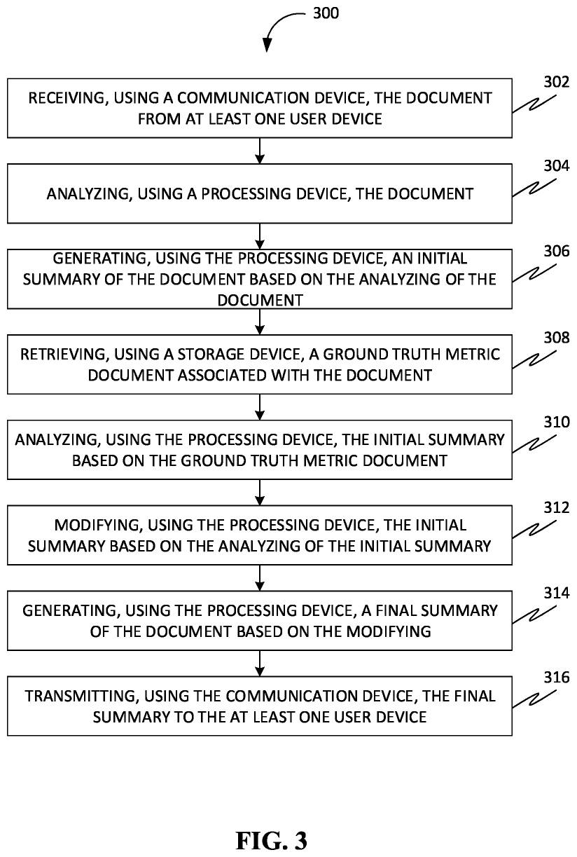

FIG. 3 is a flowchart of a method 300 for facilitating summarization of a document, in accordance with some embodiments. Accordingly, at 302, the method 300 may include receiving, using a communication device, the document from at least one user device. Further, the document may include a regulatory document.

Further, at 304, the method 300 may include a step of analyzing, using a processing device, the document.

Further, at 306, the method 300 may include a step of generating, using the processing device, an initial summary of the document based on the analyzing of the document.

Further, at 308, the method 300 may include a step of retrieving, using a storage device, a ground truth metric document associated with the document. Further, the ground truth metric document may include a reference summary. Further, the reference summary may include one or more reference points describing one or more reference concepts and one or more reference relationships between the one or more reference concepts.

Further, at 310, the method 300 may include a step of analyzing, using the processing device, the initial summary based on the ground truth metric document.

Further, at 312, the method 300 may include a step of modifying, using the processing device, the initial summary based on the analyzing of the initial summary.

Further, at 314, the method 300 may include a step of generating, using the processing device, a final summary of the document based on the modifying.

Further, at 316, the method 300 may include a step of transmitting, using the communication device, the final summary to the at least one user device.

Further, in some embodiments, the modifying of the initial summary may include adding at least one reference point of the one or more reference points of the reference summary to the initial summary. Further, the generating of the final summary of the document may be based on the adding.

Further, in some embodiments, the analyzing of the initial summary may include comparing the initial summary and the reference summary. Further, the method 300 may include a step of determining, using the processing device, a correctness of the initial summary based on the comparing of the initial summary and the reference summary. Further, the modifying of the initial summary may be based on the determining of the correctness.

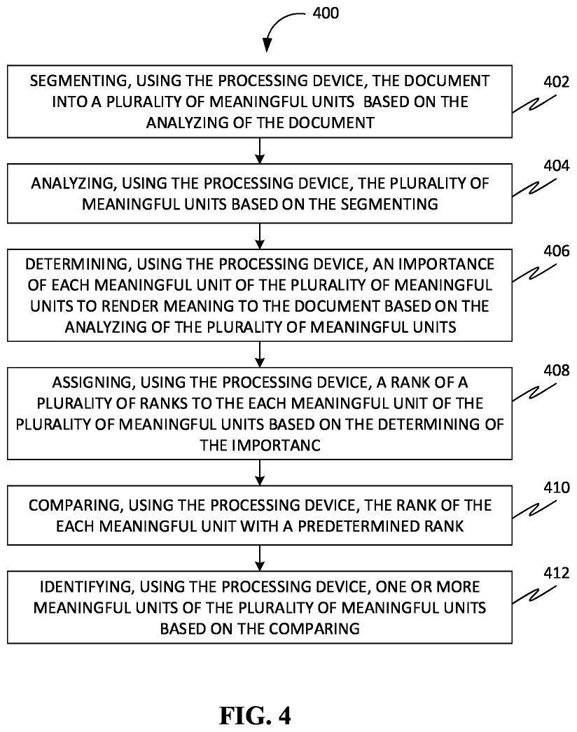

FIG. 4 is a flowchart of a method 400 for identifying one or more meaningful units for facilitating the summarization of the document, in accordance with some embodiments. Accordingly, at 402, the method 400 may include a step of segmenting, using the processing device, the document into a plurality of meaningful units based on the analyzing of the document. Further, a meaningful unit of the plurality of meaningful units may include a group of words, a sentence, a group of sentences, etc.

Further, at 404, the method 400 may include a step of analyzing, using the processing device, the plurality of meaningful units based on the segmenting.

Further, at 406, the method 400 may include a step of determining, using the processing device, an importance of each meaningful unit of the plurality of meaningful units to render meaning to the document based on the analyzing of the plurality of meaningful units.

Further, at 408, the method 400 may include a step of assigning, using the processing device, a rank of a plurality of ranks to the each meaningful unit of the plurality of meaningful units based on the determining of the importance.

Further, at 410, the method 400 may include a step of comparing, using the processing device, the rank of the each meaningful unit with a predetermined rank.

Further, at 412, the method 400 may include a step of identifying, using the processing device, the one or more meaningful units of the plurality of meaningful units based on the comparing. Further, the generating of the initial summary may be based on the identifying of the one or more meaningful units.

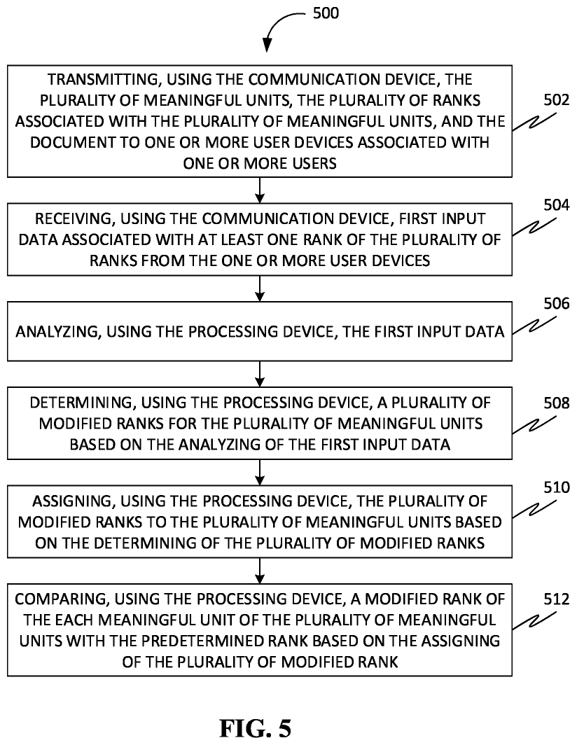

FIG. 5 is a flowchart of a method 500 for comparing a modified rank of the each meaningful unit of the plurality of meaningful units with the predetermined rank for facilitating the summarization of the document, in accordance with some embodiments. Accordingly, at 502, the method 500 may include a step of transmitting, using the communication device, the plurality of meaningful units, the plurality of ranks associated with the plurality of meaningful units, and the document to one or more user devices associated with one or more users.

Further, at 504, the method 500 may include a step of receiving, using the communication device, first input data associated with at least one rank of the plurality of ranks from the one or more user devices.

Further, at 506, the method 500 may include a step of analyzing, using the processing device, the first input data.

Further, at 508, the method 500 may include a step of determining, using the processing device, a plurality of modified ranks for the plurality of meaningful units based on the analyzing of the first input data.

Further, at 510, the method 500 may include a step of assigning, using the processing device, the plurality of modified ranks to the plurality of meaningful units based on the determining of the plurality of modified ranks.

Further, at 512, the method 500 may include a step of comparing, using the processing device, the modified rank of the each meaningful unit of the plurality of meaningful units with the predetermined rank based on the assigning of the plurality of modified ranks. Further, the identifying of the one or more meaningful units may be based on the comparing of the modified rank.

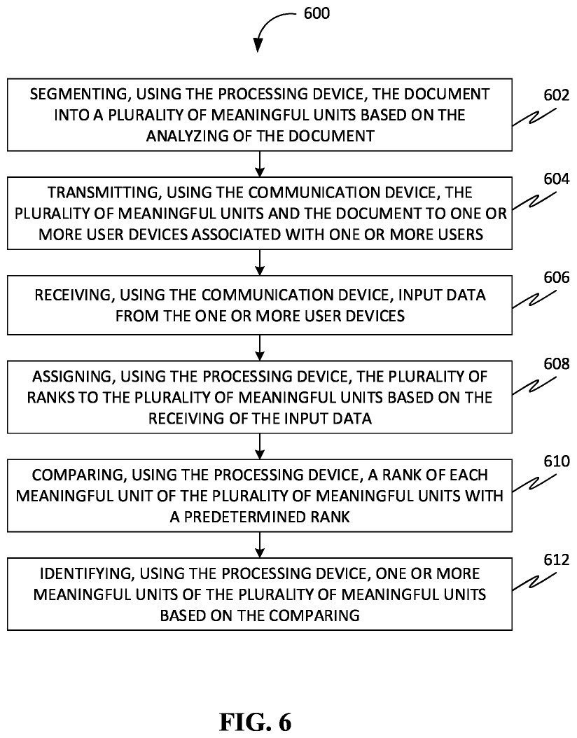

FIG. 6 is a flowchart of a method 600 for identifying one or more meaningful units of the plurality of meaningful units for facilitating the summarization of the document, in accordance with some embodiments. Accordingly, at 602, the method 600 may include a step of segmenting, using the processing device, the document into a plurality of meaningful units based on the analyzing of the document. Further, a meaningful unit of the plurality of meaningful units may include a group of words, a sentence, a group of sentences, etc.

Further, at 604, the method 600 may include a step of transmitting, using the communication device, the plurality of meaningful units and the document to one or more user devices associated with one or more users.

Further, at 606, the method 600 may include a step of receiving, using the communication device, input data from the one or more user devices. Further, the input data may include a plurality of ranks for the plurality of meaningful units.

Further, at 608, the method 600 may include a step of assigning, using the processing device, the plurality of ranks to the plurality of meaningful units based on the receiving of the input data.

Further, at 610, the method 600 may include a step of comparing, using the processing device, a rank of each meaningful unit of the plurality of meaningful units with a predetermined rank.

Further, at 612, the method 600 may include a step of identifying, using the processing device, the one or more meaningful units of the plurality of meaningful units based on the comparing. Further, the generating of the initial summary may be based on the identifying of the one or more meaningful units.

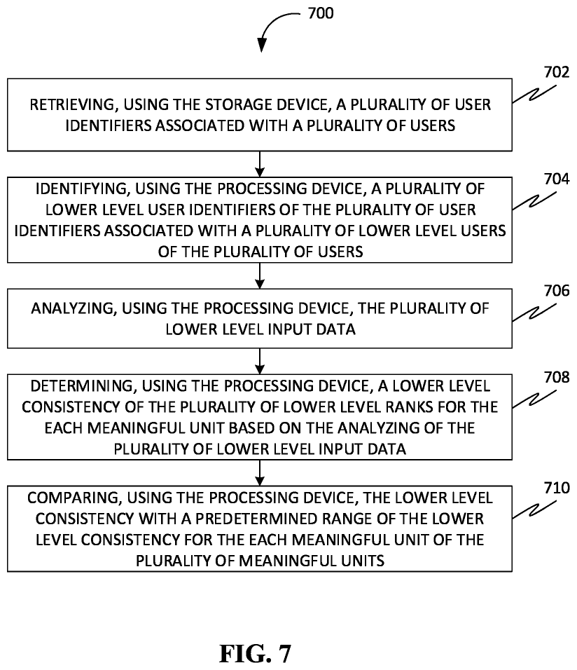

FIG. 7 is a flowchart of a method 700 for comparing a lower level consistency with a predetermined range of the lower level consistency for the each meaningful unit of the plurality of meaningful units for facilitating the summarization of the document, in accordance with some embodiments. Accordingly, at 702, the method 700 may include a step of retrieving, using the storage device, a plurality of user identifiers associated with a plurality of users. Further, the plurality of users may be associated with a plurality of hierarchical levels of a proficiency in at least one domain. Further, the document may be associated with the at least one domain. Further, the at least one domain comprises a field of study, an area of service, etc.

Further, at 704, the method 700 may include a step of identifying, using the processing device, a plurality of lower level user identifiers of the plurality of user identifiers associated with a plurality of lower level users of the plurality of users. Further, the plurality of lower level users may be associated with a lower hierarchical level of the plurality of hierarchical levels. Further, the one or more user devices may include a plurality of lower level user devices. Further, the transmitting of the plurality of meaningful units and the document to the plurality of lower level user devices may be based on the identifying of the plurality of lower level user identifiers. Further, the input data may include a plurality of lower level input data. Further, the receiving of the plurality of lower level input data from the plurality of lower level user devices may be based on the transmitting of the plurality of meaningful units and the document to the plurality of lower level user devices.

Further, at 706, the method 700 may include a step of analyzing, using the processing device, the plurality of lower level input data. Further, the plurality of lower level input data may include a plurality of lower level ranks for the each meaningful unit of the plurality of meaningful units.

Further, at 708, the method 700 may include a step of determining, using the processing device, the lower level consistency of the plurality of lower level ranks for the each meaningful unit based on the analyzing of the plurality of lower level input data.

Further, at 710, the method 700 may include a step of comparing, using the processing device, the lower level consistency with a predetermined range of the lower level consistency for the each meaningful unit of the plurality of meaningful units. Further, the assigning of the plurality of ranks to the plurality of meaningful units may be based on the comparing of the lower level consistency for the each meaningful unit of the plurality of meaningful units.

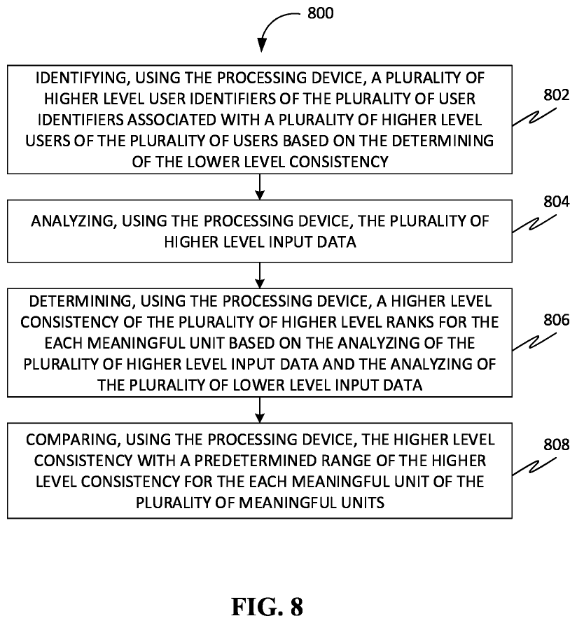

FIG. 8 is a flowchart of a method 800 for comparing a higher level consistency with a predetermined range of the higher level consistency for the each meaningful unit of the plurality of meaningful units for facilitating the summarization of the document, in accordance with some embodiments. Accordingly, at 802, the method 800 may include a step of identifying, using the processing device, a plurality of higher level user identifiers of the plurality of user identifiers associated with a plurality of higher level users of the plurality of users based on the determining of the lower level consistency. Further, a number of the plurality of higher level users may be lower than a number of the plurality of lower level users. Further, the plurality of higher level users may be associated with a higher hierarchical level of the plurality of hierarchical levels. Further, the one or more user devices may include a plurality of higher level user devices. Further, the transmitting of the plurality of meaningful units and the document to the plurality of higher level user devices may be based on the identifying of the plurality of higher level user identifiers. Further, the input data may include a plurality of higher level input data. Further, the receiving of the plurality of higher level input data from the plurality of higher level user devices may be based on the transmitting of the plurality of meaningful units and the document to the plurality of higher level user devices.

Further, at 804, the method 800 may include a step of analyzing, using the processing device, the plurality of higher level input data. Further, the plurality of higher level input data may include a plurality of higher level ranks for the each meaningful unit of the plurality of meaningful units.

Further, at 806, the method 800 may include a step of determining, using the processing device, the higher level consistency of the plurality of higher level ranks for the each meaningful unit based on the analyzing of the plurality of higher level input data and the analyzing of the plurality of lower level input data.

Further, at 808, the method 800 may include a step of comparing, using the processing device, the higher level consistency with a predetermined range of the higher level consistency for the each meaningful unit of the plurality of meaningful units. Further, the assigning of the plurality of ranks to the plurality of meaningful units may be based on the comparing of the higher level consistency for the each meaningful unit of the plurality of meaningful units.

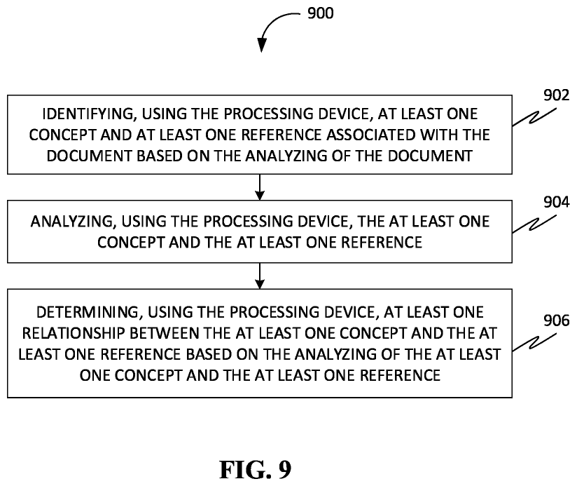

FIG. 9 is a flowchart of a method 900 for determining at least one relationship between at least one concept and at least one reference for facilitating the summarization of the document, in accordance with some embodiments. Accordingly, at 902, the method 900 may include a step of identifying, using the processing device, at least one concept and at least one reference associated with the document based on the analyzing of the document.

Further, at 904, the method 900 may include a step of analyzing, using the processing device, the at least one concept and the at least one reference.

Further, at 906, the method 900 may include a step of determining, using the processing device, the at least one relationship between the at least one concept and the at least one reference based on the analyzing of the at least one concept and the at least one reference. Further, the at least one relationship may include at least one link, at least one similarity, etc. Further, the generating of the initial summary may be based on the determining of the at least one relationship. Further, the generating of the initial summary may include creating at least one natural language sentence based on the at least one relationship between the at least one concept and the at least one reference. Further, the at least one natural language sentence may include an English language sentence.

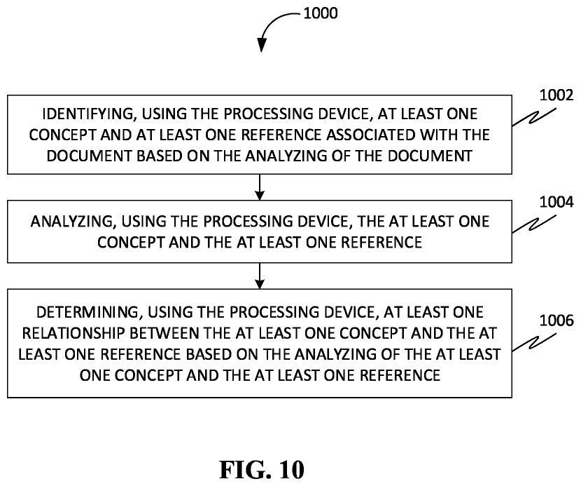

FIG. 10 is a flowchart of a method 1000 for determining at least one relationship between the at least one concept and the at least one reference for facilitating the summarization of the document, in accordance with some embodiments. Accordingly, at 1002, the method 1000 may include a step of identifying, using the processing device, at least one concept and at least one reference associated with the document based on the analyzing of the document.

Further, at 1004, the method 1000 may include a step of analyzing, using the processing device, the at least one concept and the at least one reference.

Further, at 1006, the method 1000 may include a step of determining, using the processing device, the at least one relationship between the at least one concept and the at least one reference based on the analyzing of the at least one concept and the at least one reference. Further, the at least one relationship may include at least one link, at least one similarity, etc. Further, the generating of the initial summary may be based on the determining. Further, the generating of the initial summary may include creating at least one fact based on the at least one relationship between the at least one concept and the at least one reference. Further, the at least one fact may be expressed in at least one statistical representation. Further, the at least one statistical representation may include a table, a chart, etc.

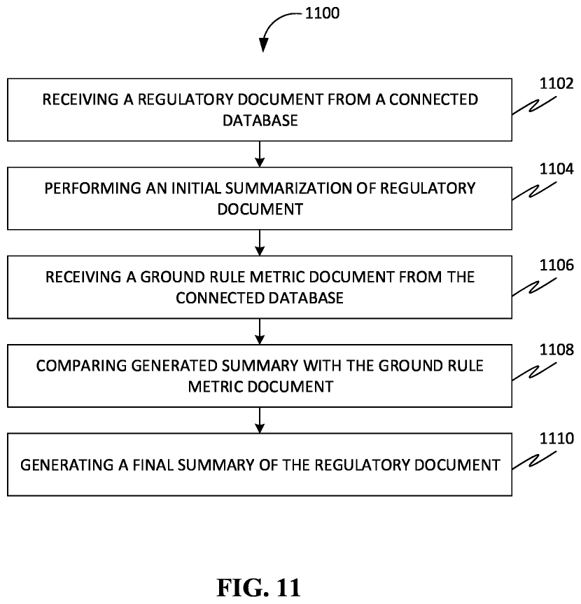

FIG. 11 is a flowchart of a method 1100 to facilitate the summarization of regulatory documents, in accordance with some embodiments. Accordingly, at 1102, the method 1100 may include a step of receiving a regulatory document from a connected database (or at least one connected database). The connected database may include databases that may store regulatory documents, such as legal databases, medical databases, engineering databases, and so on. The regulatory document may include supporting data such as the title, name, source, and so on.

Further, at 1104, the method 1100 may include a step of performing an initial summarization of the regulatory document. The summarization of the regulatory document may be performed by extractive summarization. Extractive summarization may include a word and sentence segmentation process. The contents of the regulatory document may be analyzed, and the value of each sentence may be determined based on the use of the words in the sentence, and the context of the sentence in the regulatory document. Accordingly, the sentences may be given specific weight with respect to the context of the overall use of the sentence of the document. Accordingly, a text summary that may be a compression of the original text of the regulatory document may be generated through sentence extraction.

Alternatively, the summarization of the regulatory document may be performed by abstractive summarization. Multiple algorithms, such as scrapers may be used to extract the data from the regulatory documents. Further, algorithms such as crawlers may be used to index the received regulatory documents. Further, the text of the regulatory document may also be analyzed using natural language processing techniques. For instance, distributional semantics techniques, which may help in analyzing the regulatory document based on the words used in the regulatory document. Accordingly, the key concepts and references in the regulatory document may be analyzed and important links and similarities between the concepts and references may be determined. Accordingly, text summary that may represent the distillation of the content of the regulatory document may be created by the reduction of the regulatory document into newly-created passages of text reflecting the most important themes or topics in the regulatory documents in the form of natural English sentences.

Further, in some embodiments, the summarization of the regulatory document may be performed by numeric summarization. Multiple algorithms, such as scrapers may be used to extract the data from the regulatory document. Further, algorithms such as crawlers may be used to index the received regulatory document. Further, the text of the regulatory document may also be analyzed using natural language processing techniques. For instance, distributional semantics techniques may help in analyzing the regulatory document based on the words used in the regulatory document. Initially, key concepts and references in the regulatory document may be identified and the important links and similarities between the concepts may be established. Further, the regulatory document may be reduced to the most important facts, which may be expressed in the form of tables and charts of statistical summaries. Accordingly, a numerical summary that may represent the distillation of the content of the regulatory document into newly created passages of text reflecting the most important themes or topics in the regulatory document may be created.

Further, at 1106, the method 1100 may include a step of receiving a ground truth metric document from the connected database. Further, the ground truth metric document may be a document that may be used as a reference against which a summary of the regulatory document may be analyzed to check whether the generated summary may be accurate or not. For instance, an agency may record the status of a regulation, and update the change in status and history of the regulation in an agenda document. Accordingly, the agenda document may be considered a ground truth metric document to evaluate the summary generated for the regulation. The connected database from which the ground truth metric document may be retrieved may include databases that may store regulatory documents, such as legal databases, medical databases, engineering databases, and so on. The regulatory documents may include supporting data such as the title, name, source, and so on.

Further, at 1108, the method 1100 may include a step of comparing the generated summary with the ground rule metric document. Further, the generated summary may be evaluated against the ground truth metric document to verify and authenticate the correctness of the generated summary.

Further, at 1110, the method 1100 may include a step of generating a final summary of the regulatory document. A final summary may be generated after analysis of an initial summary of the regulatory document against the ground truth metric document. The summary may be revised based on the evaluation of the initial summary with respect to the ground truth metric document. For instance, if an important point is found to be lacking in a summary, the point may be added to complete the summary. Accordingly, the ground truth metric document may be used as a source for additional content to be added to the summary.

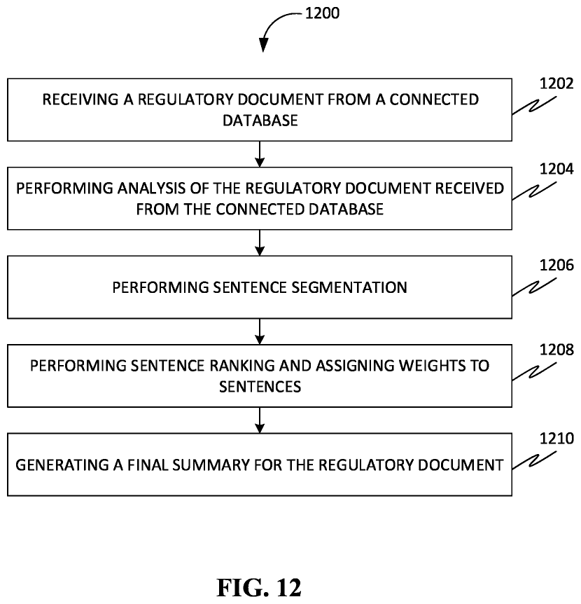

FIG. 12 is a flowchart of a method 1200 to facilitate the summarization of a regulatory document, in accordance with some embodiments. Accordingly, at 1202, the method 1200 may include a step of receiving a regulatory document (or at least one regulatory document) from a connected database (or at least one connected database). The connected database may include databases that may store regulatory documents, such as legal databases, medical databases, engineering databases, and so on. The regulatory document may include supporting data such as the title, name, source, and so on.

Further, 1204, the method 1200 may include a step of performing analysis of the regulatory document received from the connected database. The analysis of the received regulatory document may be performed by the use of text recognition algorithms. Algorithms, such as scrapers may be used to extract the data from the regulatory documents. Further, algorithms such as crawlers may be used to index the received regulatory documents. Further, the text of the documents may be analyzed using natural language processing techniques. For instance, distributional semantics techniques may help in analyzing the regulatory documents based on the words, and the meaning of the words used in the regulatory documents in accordance with the context of the used words in the regulatory document. Accordingly, the key concepts and references in the regulatory document may be analyzed and important links and similarities between the concepts and references may be determined.

Further, at 1206, the method 1200 may include a step of performing sentence segmentation in the regulatory document. After the analysis of the regulatory document, the text of the regulatory document may be divided into meaningful units. The meaningful units may include important words, which may be analyzed and determined to provide meaning to sentences. Further, the meaningful units may include sentences and a collection of sentences that may pertain to individual topics. Accordingly, the meaningful units may also include individual topics and headings in the regulatory document. Sentence segmentation may be performed by analysis of punctuation, such as a full stop. However, in the English language, the full stop character may also be used for abbreviations, which may or may not also terminate a sentence. Accordingly, if punctuation and similar clues may not be available, the task of sentence segmentation may be performed through statistical decision-making, large dictionaries, and through analysis of syntactic and semantic constraints. Further, sentence segmentation through natural language processing may be differently applied to text in specific domains and sources. Accordingly, different types of regulatory documents may have to be analyzed, and sentence segmentation may have to be performed in a different manner. For instance, analysis and processing of text in agenda documents may be different from processing text in other regulatory documents such as enforcements.

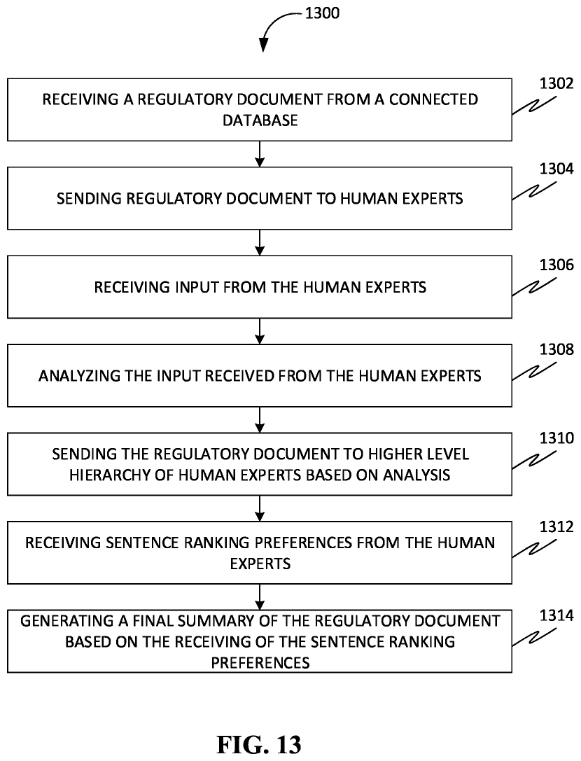

Further, at 1208, the method 1200 may include a step of performing sentence ranking and assigning weights to sentences. After sentence segmentation, the sentences in the regulatory document may be analyzed and ranked. The rank of a sentence may be defined by the importance of a sentence to render meaning to a regulatory document. For instance, if the regulatory document is an enforcement issued to an organization for breach of a legal statutes and/or regulations, the sentences containing the details about the action, and violation may be ranked higher than the sentences containing the name of the respondent, and the details about the penalty. Further, the preferences for ranking of sentences may also be received from a human expert. The human experts may select the sentences that may be ranked higher than other sentences. The process of using of input from human experts has been explained in detail in conjunction with FIG. 13. Accordingly, the higher ranked sentences may be given higher weight. The sentences may also be ranked and weighted for every individual topic and heading.

Further, at 1210, the method 1200 may include a step of generating a final summary of the regulatory document. The summary may be generated by combining the highest ranked sentences in a correct order. Further, the highest ranked sentences from each topic and headline may be used to generate the final summary of the regulatory document to make the generated summary complete and comprehensive. Accordingly, a text summary that may be a “compression” of the original text of the regulatory document may be achieved.

FIG. 13 is a flowchart of a method 1300 to facilitate the summarization of a regulatory document, in accordance with some embodiments. Accordingly, at 1302, the method 1300 may include a step of receiving a regulatory document (or at least one regulatory document) from a connected database (or at least one connected database). The connected database may include databases that may store regulatory documents, such as legal databases, medical databases, engineering databases, and so on. The regulatory document may include supporting data such as the title, name, source, and so on.

Further, at 1304, the method 1300 may include a step of sending the regulatory document to human experts (or multiple human experts). The human experts may be users, who may be proficient or experts in the particular field or topic that the regulatory documents may pertain to or include. For instance, a student who may be studying economics may be sent a regulatory document that may pertain to lending, and a user who may be a working professional in the banking sector may be sent a regulatory document that may pertain to mortgages.

Further, at 1306, the method 1300 may include a step of receiving input from the human experts. The input may be received from the human experts through user devices. The human experts may perform a detailed manual analysis of the regulatory document. Further, the human experts may rank individual sentences in the regulatory document. Further, the human experts may weigh the sentences of the regulatory document and analyze which sentence or sentences help in identification of the topic or category of the regulatory document, and include most of the meaning of the regulatory document. For instance, in the financial services domain, some agencies may enforce legal statutes and regulations by issuing an enforcement action. An enforcement may be a document that may contain an action detailing the incident detailing the breach of a statute or regulation, the name of a respondent, who may be addressed in the enforcement, a penalty detailing the fine, or any other punishment that may be issued to the respondent, and the violation stating a legal citation, statute or regulation violated by the respondent. Human experts may analyze the enforcement and may select the sentences, phrases, and/or words that may describe the action and violation detailing the legal citation, statute, or regulation.

Further, at 1308, the method 1300 may include a step of analyzing the input received from the human experts. The input received may be analyzed to improve machine-learning algorithms that may make use of the input to analyze the regulatory document, assign weights to sentences, rank, and re-rank sentences in the regulatory document. Further, the input of the multiple human experts may be analyzed to determine whether a majority of human experts rank the sentences in the regulatory document similarly, assign similar ranks, and provide similar weight to the same sentences in the regulatory document.

Further, at 1310, the method 1300 may include a step of sending the regulatory document to a higher level of hierarchy of human experts based on analysis of the input. If a predefined number of the human experts rank the sentences in the regulatory document similar to a particular regulatory document, the judgment may be accepted and used in the improvement of machine learning algorithms to analyze and categorize the regulatory documents. Alternatively, if the human experts do not rank the sentences in the regulatory document similarly, the regulatory document may be transferred to a higher hierarchical level of human experts for judgment. The number of human experts in the higher hierarchical level of judgment may be lower than the lower level. Further, the expertise and proficiency of the human experts in the higher hierarchical level of judgment may be more than the human experts in the lower hierarchical level of judgment. Further, the process of analysis and categorization of regulatory documents may be repeated until a predetermined number of human experts rank the sentences in the regulatory document similarly.

Further, at 1312, the method 1300 may include a step of receiving sentence-ranking preferences from the human experts. Further, the receiving of the sentence-ranking preferences from human expert may aid in the generation of summaries The process of analysis and categorization of regulatory documents may be repeated until a predetermined number of human experts rank the sentences in the regulatory document similarly. Accordingly, when a predetermined number of human experts rank the sentences in a regulatory document similarly, the ranking may be accepted.

Further, at 1314, the method 1300 may include a step of generating a final summary of the regulatory document based on the receiving of the sentence ranking preferences. The summary may be generated by combining the highest ranked sentences in a correct order. Further, the highest ranked sentences from each topic and headline may be used to generate the final summary of the regulatory document to make the generated summary complete and comprehensive. Accordingly, a text summary that may be a “compression” of the original text of the regulatory document may be achieved. Further, the preferences of ranking sentences may be used to improve the process of automatic analysis of a regulatory document and extracting meaningful sentences to generate a comprehensive summary of the regulatory document.

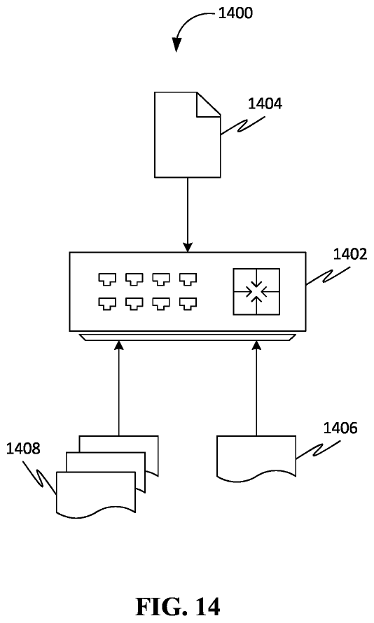

FIG. 14 illustrates a system 1400 to facilitate the summarization of a regulatory document in accordance with some embodiments. Accordingly, the system 1400 may include a summarization module 1402 that may summarize the regulatory document. Further, the summarization module 1402 may be configured for receiving a ground truth metric document 1404 from an external database (or connected database). Further, the ground truth metric document 1404 may include a document that may be used as a reference against which a summary of the regulatory document may be analyzed to check whether the summary generated may be accurate or not. For instance, an agency may record the status of a regulation, and update the change in status and history of the regulation in an agenda document. Accordingly, the agenda document may be considered the ground truth metric document 1404 to evaluate the summary generated by the system 1400 for the regulation document. The connected database from which the ground truth metric document 1404 may be retrieved may include databases that may store regulatory documents, such as legal databases, medical databases, engineering databases, and so on. Further, the summarization module 1402 may receive a test summary 1406 that may have been generated by the system 1400. The test summary 1406 may have been generated by the system 1400 for the regulatory document. Further, the summarization module 1402 may receive a training set of documents 1408. Further, the training set of documents 1408 may include the regulatory documents that may have been analyzed by human experts. Further, after the analysis, the sentences in the training set of documents 1408 may have been ranked, and weighted by human experts for the process of generation of summaries. Further, sentence-ranking preferences for the regulatory documents in the training set of documents 1408 may be received and the highest ranked sentences from each topic and headline of the training set of documents 1408 may be used to generate a final summary of the regulatory documents to make the generated summary complete and comprehensive. Further, the sentence-ranking preferences for the regulatory documents may be analyzed and utilized to generate the summary of regulatory documents and improve the test summary 1406 generated by the system 1400. Further, the ground truth metric document 1404 may be analyzed using natural language processing, semantics, and by ranking the sentences of the ground truth metric document 1404 through sentence-ranking preferences. Further, an improved test summary may be evaluated against the ground truth metric document 1404 to verify and authenticate the correctness of the summary generated.

Further, a final summary of the regulatory document may be generated after analysis of the summary of the regulatory document against the ground truth metric document 1404. The final summary may be revised based on the evaluation of the summary with respect to the ground truth metric document 1404. Further, the ground truth metric document 1404 may be used as a source to add data and complete the summary generated by the system 1400. For instance, if an important point is found to be lacking in a summary, the point may be added to complete the summary.

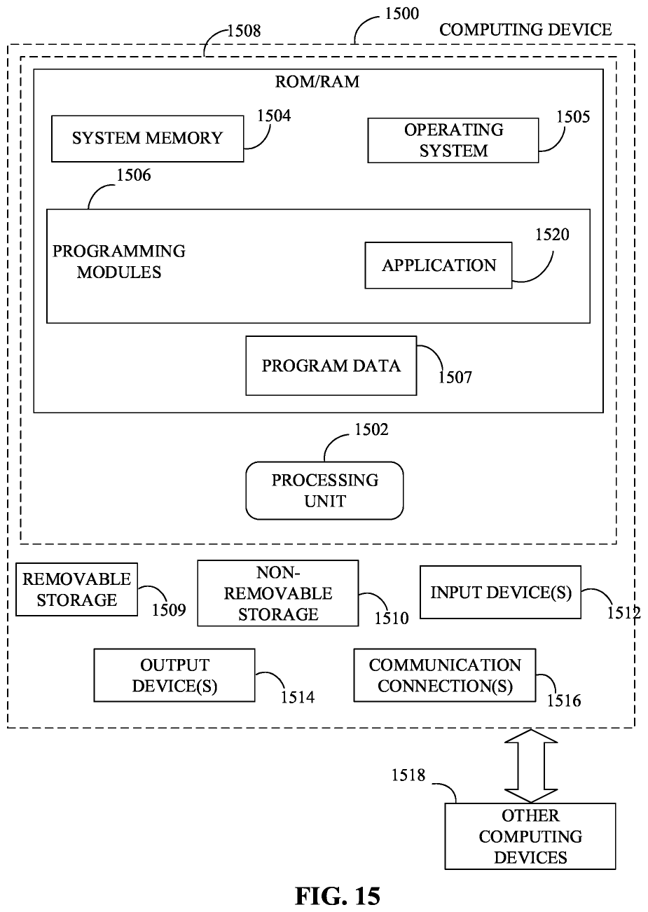

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating summarization of a document, the method comprising:
receiving, using a communication device, the document from at least one user device;
analyzing, using a processing device, the document;
generating, using the processing device, an initial summary of the document based on the analyzing of the document;
retrieving, using a storage device, a ground truth metric document associated with the document, wherein the ground truth metric document comprises a reference summary, wherein the reference summary comprises one or more reference points describing one or more reference concepts and one or more reference relationships between the one or more reference concepts;
analyzing, using the processing device, the initial summary based on the ground truth metric document;
modifying, using the processing device, the initial summary based on the analyzing of the initial summary;
generating, using the processing device, a final summary of the document based on the modifying; and
transmitting, using the communication device, the final summary to the at least one user device.

2. The method of claim 1 further comprising:
segmenting, using the processing device, the document into a plurality of meaningful units based on the analyzing of the document;
analyzing, using the processing device, the plurality of meaningful units based on the segmenting;
determining, using the processing device, an importance of each meaningful unit of the plurality of meaningful units to render meaning to the document based on the analyzing of the plurality of meaningful units;
assigning, using the processing device, a rank of a plurality of ranks to the each meaningful unit of the plurality of meaningful units based on the determining of the importance;
comparing, using the processing device, the rank of the each meaningful unit with a predetermined rank; and
identifying, using the processing device, one or more meaningful units of the plurality of meaningful units based on the comparing, wherein the generating of the initial summary is further based on the identifying of the one or more meaningful units.

3. The method of claim 2 further comprising:
transmitting, using the communication device, the plurality of meaningful units, the plurality of ranks associated with the plurality of meaningful units, and the document to one or more user devices associated with one or more users;
receiving, using the communication device, first input data associated with at least one rank of the plurality of ranks from the one or more user devices;
analyzing, using the processing device, the first input data;
determining, using the processing device, a plurality of modified ranks for the plurality of meaningful units based on the analyzing of the first input data;
assigning, using the processing device, the plurality of modified ranks to the plurality of meaningful units based on the determining of the plurality of modified ranks; and
comparing, using the processing device, a modified rank of the each meaningful unit of the plurality of meaningful units with the predetermined rank based on the assigning of the plurality of modified ranks, wherein the identifying of the one or more meaningful units is further based on the comparing of the modified rank.

4. The method of claim 1 further comprising:
segmenting, using the processing device, the document into a plurality of meaningful units based on the analyzing of the document;
transmitting, using the communication device, the plurality of meaningful units and the document to one or more user devices associated with one or more users;
receiving, using the communication device, input data from the one or more user devices, wherein the input data comprises a plurality of ranks for the plurality of meaningful units;
assigning, using the processing device, the plurality of ranks to the plurality of meaningful units based on the receiving of the input data;
comparing, using the processing device, a rank of each meaningful unit of the plurality of meaningful units with a predetermined rank; and
identifying, using the processing device, one or more meaningful units of the plurality of meaningful units based on the comparing, wherein the generating of the initial summary is further based on the identifying of the one or more meaningful units.

5. The method of claim 4 further comprising:
retrieving, using the storage device, a plurality of user identifiers associated with a plurality of users, wherein the plurality of users is associated with a plurality of hierarchical levels of a proficiency in at least one domain, wherein the document is associated with the at least one domain;
identifying, using the processing device, a plurality of lower level user identifiers of the plurality of user identifiers associated with a plurality of lower level users of the plurality of users, wherein the plurality of lower level users is associated with a lower hierarchical level of the plurality of hierarchical levels, wherein the one or more user devices comprises a plurality of lower level user devices, wherein the transmitting of the plurality of meaningful units and the document to the plurality of lower level user devices is based on the identifying of the plurality of lower level user identifiers, wherein the input data comprises a plurality of lower level input data, wherein the receiving of the plurality of lower level input data from the plurality of lower level user devices is based on the transmitting of the plurality of meaningful units and the document to the plurality of lower level user devices;
analyzing, using the processing device, the plurality of lower level input data, wherein the plurality of lower level input data comprises a plurality of lower level ranks for the each meaningful unit of the plurality of meaningful units;
determining, using the processing device, a lower level consistency of the plurality of lower level ranks for the each meaningful unit based on the analyzing of the plurality of lower level input data; and
comparing, using the processing device, the lower level consistency with a predetermined range of the lower level consistency for the each meaningful unit of the plurality of meaningful units, wherein the assigning of the plurality of ranks to the plurality of meaningful units is further based on the comparing of the lower level consistency for the each meaningful unit of the plurality of meaningful units.

6. The method of claim 5 further comprising:
identifying, using the processing device, a plurality of higher level user identifiers of the plurality of user identifiers associated with a plurality of higher level users of the plurality of users based on the determining of the lower level consistency, wherein a number of the plurality of higher level users is lower than a number of the plurality of lower level users, wherein the plurality of higher level users is associated with a higher hierarchical level of the plurality of hierarchical levels, wherein the one or more user devices comprises a plurality of higher level user devices, wherein the transmitting of the plurality of meaningful units and the document to the plurality of higher level user devices is based on the identifying of the plurality of higher level user identifiers, wherein the input data comprises a plurality of higher level input data, wherein the receiving of the plurality of higher level input data from the plurality of higher level user devices is based on the transmitting of the plurality of meaningful units and the document to the plurality of higher level user devices;
analyzing, using the processing device, the plurality of higher level input data, wherein the plurality of higher level input data comprises a plurality of higher level ranks for the each meaningful unit of the plurality of meaningful units;
determining, using the processing device, a higher level consistency of the plurality of higher level ranks for the each meaningful unit based on the analyzing of the plurality of higher level input data and the analyzing of the plurality of lower level input data; and
comparing, using the processing device, the higher level consistency with a predetermined range of the higher level consistency for the each meaningful unit of the plurality of meaningful units, wherein the assigning of the plurality of ranks to the plurality of meaningful units is further based on the comparing of the higher level consistency for the each meaningful unit of the plurality of meaningful units.

7. The method of claim 1 further comprising:
identifying, using the processing device, at least one concept and at least one reference associated with the document based on the analyzing of the document;
analyzing, using the processing device, the at least one concept and the at least one reference; and
determining, using the processing device, at least one relationship between the at least one concept and the at least one reference based on the analyzing of the at least one concept and the at least one reference, wherein the generating of the initial summary is further based on the determining of the at least one relationship, wherein the generating of the initial summary comprises creating at least one natural language sentence based on the at least one relationship between the at least one concept and the at least one reference.

8. The method of claim 1 further comprising:
identifying, using the processing device, at least one concept and at least one reference associated with the document based on the analyzing of the document;
analyzing, using the processing device, the at least one concept and the at least one reference; and
determining, using the processing device, at least one relationship between the at least one concept and the at least one reference based on the analyzing of the at least one concept and the at least one reference, wherein the generating of the initial summary is further based on the determining, wherein the generating of the initial summary comprises creating at least one fact based on the at least one relationship between the at least one concept and the at least one reference, wherein the at least one fact is expressed in at least one statistical representation.

9. The method of claim 1, wherein the modifying of the initial summary comprises adding at least one reference point of the one or more reference points of the reference summary to the initial summary, wherein the generating of the final summary of the document is based on the adding.

10. The method of claim 1, wherein the analyzing of the initial summary comprises comparing the initial summary and the reference summary, wherein the method further comprises determining, using the processing device, a correctness of the initial summary based on the comparing of the initial summary and the reference summary, wherein the modifying of the initial summary is further based on the determining of the correctness.

11. A system for facilitating summarization of a document, the system comprising:
a communication device configured for:
receiving the document from at least one user device; and
transmitting a final summary to the at least one user device;
a processing device communicatively coupled with the communication device, wherein the processing device is configured for:
analyzing the document;
generating an initial summary of the document based on the analyzing of the document;
analyzing the initial summary based on a ground truth metric document;
modifying the initial summary based on the analyzing of the initial summary; and
generating the final summary of the document based on the modifying; and
a storage device communicatively coupled with the processing device, wherein the storage device is configured for retrieving the ground truth metric document associated with the document, wherein the ground truth metric document comprises a reference summary, wherein the reference summary comprises one or more reference points describing one or more reference concepts and one or more reference relationships between the one or more reference concepts.

12. The system of claim 11, wherein the processing device is further configured for:
segmenting the document into a plurality of meaningful units based on the analyzing of the document;
analyzing the plurality of meaningful units based on the segmenting;
determining an importance of each meaningful unit of the plurality of meaningful units to render meaning to the document based on the analyzing of the plurality of meaningful units;
assigning a rank of a plurality of ranks to the each meaningful unit of the plurality of meaningful units based on the determining of the importance;
comparing the rank of the each meaningful unit with a predetermined rank; and
identifying one or more meaningful units of the plurality of meaningful units based on the comparing, wherein the generating of the initial summary is further based on the identifying of the one or more meaningful units.

13. The system of claim 12, wherein the communication device is further configured for:
transmitting the plurality of meaningful units, the plurality of ranks associated with the plurality of meaningful units, and the document to one or more user devices associated with one or more users; and
receiving first input data associated with at least one rank of the plurality of ranks from the one or more user devices, wherein the processing device is further configured for:
analyzing the first input data;
determining a plurality of modified ranks for the plurality of meaningful units based on the analyzing of the first input data;
assigning the plurality of modified ranks to the plurality of meaningful units based on the determining of the plurality of modified ranks; and
comparing a modified rank of the each meaningful unit of the plurality of meaningful units with the predetermined rank based on the assigning of the plurality of modified ranks, wherein the identifying of the one or more meaningful units is further based on the comparing of the modified rank.

14. The system of claim 11, wherein the processing device is further configured for:
segmenting the document into a plurality of meaningful units based on the analyzing of the document;
assigning a plurality of ranks to the plurality of meaningful units based on the receiving of input data;
comparing a rank of each meaningful unit of the plurality of meaningful units with a predetermined rank; and
identifying one or more meaningful units of the plurality of meaningful units based on the comparing, wherein the communication device is further configured for:
transmitting the plurality of meaningful units and the document to one or more user devices associated with one or more users; and
receiving the input data from the one or more user devices, wherein the input data comprises the plurality of ranks for the plurality of meaningful units, wherein the generating of the initial summary is further based on the identifying of the one or more meaningful units.

15. The system of claim 14, wherein the storage device is further configured for retrieving a plurality of user identifiers associated with a plurality of users, wherein the plurality of users is associated with a plurality of hierarchical levels of a proficiency in at least one domain, wherein the document is associated with the at least one domain, wherein the processing device is further configured for:
identifying a plurality of lower level user identifiers of the plurality of user identifiers associated with a plurality of lower level users of the plurality of users, wherein the plurality of lower level users is associated with a lower hierarchical level of the plurality of hierarchical levels, wherein the one or more user devices comprises a plurality of lower level user devices, wherein the transmitting of the plurality of meaningful units and the document to the plurality of lower level user devices is based on the identifying of the plurality of lower level user identifiers, wherein the input data comprises a plurality of lower level input data, wherein the receiving of the plurality of lower level input data from the plurality of lower level user devices is based on the transmitting of the plurality of meaningful units and the document to the plurality of lower level user devices;
analyzing the plurality of lower level input data, wherein the plurality of lower level input data comprises a plurality of lower level ranks for the each meaningful unit of the plurality of meaningful units;
determining a lower level consistency of the plurality of lower level ranks for the each meaningful unit based on the analyzing of the plurality of lower level input data; and
comparing the lower level consistency with a predetermined range of the lower level consistency for the each meaningful unit of the plurality of meaningful units, wherein the assigning of the plurality of ranks to the plurality of meaningful units is further based on the comparing of the lower level consistency for the each meaningful unit of the plurality of meaningful units.

16. The system of claim 15, wherein the processing device is further configured for:
identifying a plurality of higher level user identifiers of the plurality of user identifiers associated with a plurality of higher level users of the plurality of users based on the determining of the lower level consistency, wherein a number of the plurality of higher level users is lower than a number of the plurality of lower level users, wherein the plurality of higher level users is associated with a higher hierarchical level of the plurality of hierarchical levels, wherein the one or more user devices comprises a plurality of higher level user devices, wherein the transmitting of the plurality of meaningful units and the document to the plurality of higher level user devices is based on the identifying of the plurality of higher level user identifiers, wherein the input data comprises a plurality of higher level input data, wherein the receiving of the plurality of higher level input data from the plurality of higher level user devices is based on the transmitting of the plurality of meaningful units and the document to the plurality of higher level user devices;
analyzing the plurality of higher level input data, wherein the plurality of higher level input data comprises a plurality of higher level ranks for the each meaningful unit of the plurality of meaningful units;
determining a higher level consistency of the plurality of higher level ranks for the each meaningful unit based on the analyzing of the plurality of higher level input data and the analyzing of the plurality of lower level input data; and
comparing the higher level consistency with a predetermined range of the higher level consistency for the each meaningful unit of the plurality of meaningful units, wherein the assigning of the plurality of ranks to the plurality of meaningful units is further based on the comparing of the higher level consistency for the each meaningful unit of the plurality of meaningful units.

17. The system of claim 11, wherein the processing device is further configured for:
identifying at least one concept and at least one reference associated with the document based on the analyzing of the document;
analyzing the at least one concept and the at least one reference; and
determining at least one relationship between the at least one concept and the at least one reference based on the analyzing of the at least one concept and the at least one reference, wherein the generating of the initial summary is further based on the determining of the at least one relationship, wherein the generating of the initial summary comprises creating at least one natural language sentence based on the at least one relationship between the at least one concept and the at least one reference.

18. The system of claim 11, wherein the processing device is further configured for:
identifying at least one concept and at least one reference associated with the document based on the analyzing of the document;
analyzing the at least one concept and the at least one reference; and
determining at least one relationship between the at least one concept and the at least one reference based on the analyzing of the at least one concept and the at least one reference, wherein the generating of the initial summary is further based on the determining, wherein the generating of the initial summary comprises creating at least one fact based on the at least one relationship between the at least one concept and the at least one reference, wherein the at least one fact is expressed in at least one statistical representation.

19. The system of claim 11, wherein the modifying of the initial summary comprises adding at least one reference point of the one or more reference points of the reference summary to the initial summary, wherein the generating of the final summary of the document is based on the adding.

20. The system of claim 11, wherein the analyzing of the initial summary comprises comparing the initial summary and the reference summary, wherein the processing device is further configured for determining a correctness of the initial summary based on the comparing of the initial summary and the reference summary, wherein the modifying of the initial summary is further based on the determining of the correctness.
